(19) United States
(12) Patent Application Publication
(10) Pub. No.: US 2004/0052485 A1
(43) Pub. Date: Mar. 18, 2004

(54) Terminating polymer optical fibre

(76) Inventors: Martijn Van Eijkelenborg, Newtown (AU); Simon C. Fleming, Lane Cove (AU); Ian Maxwell, Five Dock (AU)

Correspondence Address: FOLEY AND LARDNER, SUITE 500, 3000 K STREET NW, WASHINGTON, DC, 20007, US

(21) Appl. No.: 10/432,016

(22) PCT Filed: Nov. 21, 2001
(86) PCT No.: PCT/AU01/01523

(30) Foreign Application Priority Data
Nov. 21, 2000 (AU) PQ1594

(51) Int. Cl. G02B 6/20; G02B 6/255

(52) U.S. Cl. 385/125; 385/96

(57) ABSTRACT

A method of terminating a polymer optical fibre (10) having a longitudinally extending light guiding cor region (11) and longitudinally extending channel-like light confining holes (13). The method comprises restricting a cross-sectional area of the some or all of the holes over a portion of their length adjacent and extending to a terminal end (14) of the optical fibre (10). The cross-sectional area of the holes is restricted, using the inherent properties of the polymeric material, in a manner effectively to increase the cross-sectional area of the light guiding region (11) of the optical fibre (10) adjacent its terminal end (14). Further, a method of splicing two of such polymer optical fibres (10) comprising terminating each of the optical fibres by the above-defined method, aligning them and conjoining their terminal ends (14).

### FIELD OF THE INVENTION

This invention relates to a method of terminating optical fibre of the type formed from a polymeric material and having a longitudinally extending light guiding core region and surrounding light confining elements in the form of longitudinally extending channel-like holes. The invention has application to the class of optical fibres that are known as photonic crystal fibres, including those disclosed in International patent application No. PCT/AU01/00890 dated Jul. 23, 2001, and to polymer optical fibres, for example of the type that are disclosed in International Patent Application PCT/AU01/00891 dated Jul. 20, 2001.

The invention is hereinafter described in the context of photonic crystal fibres but it will be understood that the invention does have broader application.

### BACKGROUND OF THE INVENTION

Polymer optical fibres are recognised as having potential application as low cost, broad bandwidth, easy-to-install waveguides. These features make them eminently suitable for use as relatively short length high-speed date transmission lines, typically in local area network and residential signal transmission applications. For such applications it often required to couple different light transmitting media.

The success of light transmission into, between and from an optical fibre is determined at least in part by the level of alignment that is established between the light guiding core region of the optical fibre and a waveguide or other device from or into which the light is coupled. This applies to source-to-fibre coupling, fibre-to-fibre splicing and fibre-to-detector coupling. Similarly, the cost of coupling or splicing is determined by the intricacy of alignment in any given situation.

Alignment difficulties are exacerbated in the case of photonic crystal fibres due typically to the small size of the light guiding core regions of such fibres. These difficulties might be avoided or minimised, and the use of relatively simple splicing/connecting tools might be facilitated, if large spot size single mode photonic crystal fibres (i.e., fibres that exhibit large transverse optical intensity profiles) were to be used. However, such fibres exhibit severe bending losses and it is desirable that an alternative solution to the alignment difficulty be adopted.

Optical fibres when formed from polymeric materials provide at least a partial solution to these difficulties but it has been determined that polymer optical fibres are inherently difficult to terminate, for example to permit splicing.

International patent application WO 00/49435 (The University of Bath) dated Feb. 18, 2000 discloses a method of treating silica photonic crystal fibre with a high level of heat and elongation for the purpose of closing longitudinal holes associated with the fibre structure such that the light guiding region is caused to expand. The present invention is directed to the termination of polymeric fibres employing different approaches.

### SUMMARY OF THE INVENTION

Broadly defined, the present invention provides a method of terminating an optical fibre of the type formed from a polymeric material and having a longitudinally extending light guiding core region and light confining elements in the form of longitudinally extending channel-like holes. The method comprises restricting the cross-sectional area of at least some of the holes over a portion of their length adjacent and extending to a terminal end of the optical fibre. The cross-sectional area of the holes is restricted, using the inherent properties of the polymeric material, in a manner effectively to increase the cross-sectional area of the light guiding region of the optical fibre adjacent the terminal end of the optical fibre.

The invention may also be defined in terms of an optical device that comprises or incorporates an optical fibre which is terminated by the above defined method.

The invention may further be defined in terms of a method of splicing two optical fibres, each being of a type formed from a polymeric material and having a longitudinally extending light guiding core region and light confining elements in the form of longitudinal extending channel-like holes. The method comprises the steps of terminating each of the optical fibres by the above-defined method of terminating an optical fibre, aligning the two optical fibres and conjoining the terminal ends of the two aligned optical fibres.

The invention may be defined still further in terms of an optical device that comprises or incorporates two optical fibres which are spliced by the above defined method.

Preferred Features of the Invention

The restriction of the holes may be effected in various ways: By subjecting the terminal end region of the optical fibre to mechanical compression in a radially inward direction, by thermally collapsing the hole-surrounding material of the optical fibre by the application of a low level of heat, by filling the holes with a filling agent such as a settable liquid, or by any combination of these approaches.

The thermal collapsing of the hole-surrounding material may be effected by the application of a level of heat that is sufficient to allow thermal moulding, squeezing or reshaping. The thermal collapsing of the hole-surrounding material preferably is effected by the application of a level of heat corresponding to that used for drawing of the optical fibre.

The settable liquid may comprise a monomeric material that forms the polymeric material from which the fibre is formed. Polymerisation of the monomer will result in the terminal end of the fibre having a uniform composition and refractive index. All of these approaches are facilitated by inherent properties of polymeric materials. The cross-sectional area of the holes may be restricted partially or wholly so that, in the latter case, the restriction will be complete and the holes will be closed over a selected portion of their length adjacent the terminal end of the optical fibre. Also, some of the holes may be restricted partially and others be restricted completely.

All of the holes may be restricted, either partially or wholly, over the same distance with respect to the terminal end of the optical fibre. Alternatively, the distance over which the holes are restricted may be reduced with increasing radial distance of the holes from the light guiding core region of the optical fibre.

The restriction may be effected in a circularly symmetrical manner or in a manner to create a light guiding region that has non-circular (e.g. elliptical) symmetry. In the latter case the restriction of the holes may be effected by subjecting the terminal end region of the optical fibre to mechanical compression in a single diametrical direction.

The above defined method of splicing two optical fibres may comprise initially aligning the two fibres and subsequently effecting the terminating step simultaneously with the splicing step. The step of terminating and splicing preferably involves the application of thermal energy. The thermal energy preferably is sufficient to allow thermal moulding, squeezing or reshaping. The thermal energy most preferably corresponds to that used for drawing of the optical fibre.

The invention will be more fully understood from the following description of various forms in which the invention might be embodied. The description is provided with reference to the accompanying drawings.

### BRIEF DESCRIPTION OF THE DRAWINGS

In the drawings—

FIG. 1 shows a transverse cross-section of a typical polymer photonic crystal fibre of a type to which the present invention might be applied;

FIG. 2 shows a longitudinal view of the polymer optical fibre as seen in the direction of section plane 2.2 of FIG. 1;

FIG. 3 shows a longitudinal view of the polymer optical fibre when terminated in accordance with a first method;

FIG. 4 shows a longitudinal view of an polymer optical fibre when terminated in accordance with a second method of the invention;

FIG. 5 shows a longitudinal view of an polymer optical fibre when terminated in accordance with a third method of the invention;

FIG. 6 shows a spliced arrangement of two polymer optical fibres that are terminated by the method that is illustrated in FIG. 3; and

FIG. 7 shows an arrangement for terminating and splicing two polymer optical fibres.

### DETAILED DESCRIPTION OF THE PREFERRED FEATURES

As illustrated, a polymer photonic crystal fibre 10 typically comprises a light guiding core region 11 and a core-surrounding region 12. Light confining elements in the form of longitudinally extending channel-like holes 13 are located within the core-surrounding region 12, and each of the holes 13 normally extends for the full length of the optical fibre 10.

The holes 13 are positioned geometrically in concentric hexagonal rings that surround the core region 11, and the holes 13 normally are occupied by air. The core region 11 may be considered notionally as being located within the inner ring of holes 13 and this is illustrated most graphically in FIGS. 2 to 6. However, it will be understood that the core region 11 need not necessarily have any clearly defined outer margin.

Each of the holes will typically have a diameter in the order of 1 μm and the holes will have centre spacings in the order of 3 μm.

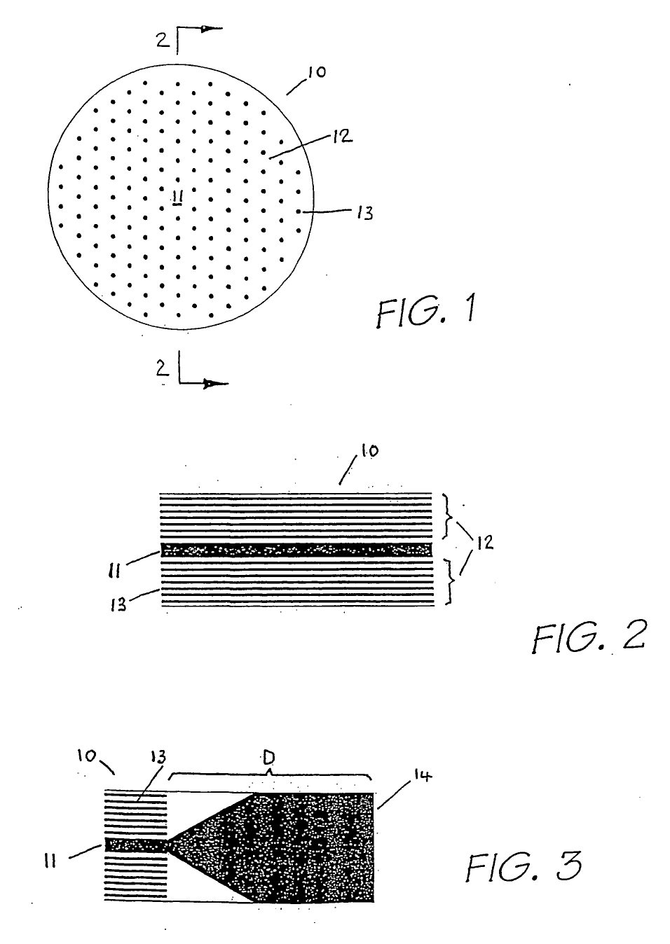

The core region 11 and the core-surrounding region 12 usually are homogeneous, in the sense that they are both formed from the same material without any interface between the two regions. Any optically transparent polymeric material may be employed in forming the core and the core surrounding regions, It will be appreciated that the invention does have application to optical fibres that have geometric structures different from that illustrated in FIG. 1. In particular the invention does have application to optical fibres of the type that are described and illustrated in the above referenced two international patent applications numbered PCT/AU01/00890 and PCT/AU01/00891.

As indicated previously, the present invention is directed to a method of terminating the polymer optical fibre by a process that involves restricting the cross-sectional area of at least some of the holes 13, in the extreme by closing all of the holes over a portion of their length at the (or each) terminal end 14 of the optical fibre. This aspect of the invention is illustrated in FIG. 3, which shows all of the holes terminated abruptly at a distance D from the terminal end 14 of the fibre.

This process effectively creates a transition from photonic crystal fibre guiding to step-index fibre guiding, causing the guided mode to expand from the small spot area in the light guiding region of the fibre to a relatively large spot area at the terminal end 14 of the fibre. However, it will be understood that, despite the fact that the holes are closed or at least partially closed, the light will continue to be confined, for example by the step in refractive index between the optical fibre and the surrounding air. In this situation guided light will expand to fill the entire fibre cross-sectional area adjacent the terminal end of the fibre, with the light being guided within the end region of the fibre by the step-index between the fibre material and surrounding air.

Problems associated with modal dispersion due to the large mode area at the terminal end of the fibre will be negligible, because the mode expansion section at the termination may be kept very short; that is equal to or slightly longer than the distance needed for the spot size to expand from the light guiding core region 11 to the desired spot size. The short termination length will ensure that most of the light will remain in the fundamental mode.

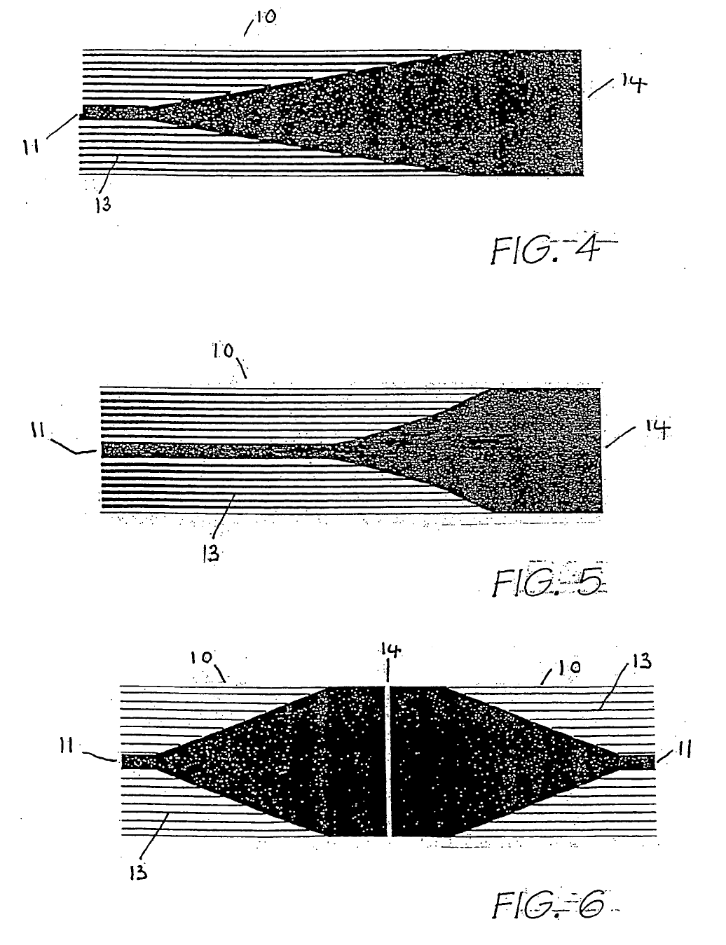

The cross sectional area of the holes 13 may be restricted in various ways. For example, the holes may be closed in the abrupt manner as illustrated in FIG. 3. Alternatively, the holes may be restricted (i.e. be closed completely) in a gradual manner, by reducing the distance D with increasing radial distance of the holes from the longitudinal axis of the fibre, as illustrated in FIG. 4. As a further alternative, the cross-sectional area of the holes may be restricted gradually by reducing the hole size over a selected length at the terminal end of the fibre, until they close completely near the terminal end. This is illustrated in FIG. 5.

Both of the gradual hole-closure methods may, in some sense, preserve the single-modedness of the fibre right up to the point where the light reaches the terminal end (i.e. the cleaved facet) of the fibre.

The gradual change in the cross-sectional area of the holes, leading to complete closure of the core-surrounding region, may be employed to reduce significantly the coupling losses in the case of source-to-fibre coupling, fibre-to-detector coupling and fibre-to-fibre splicing. The gradual change in the hole structure functions effectively to funnel the light into or from the core region of the fibre. This means that the full facet of the fibre at the terminal end may be exposed to a light source without delicate alignment procedures being required to align a focussed spot from the light source with the light guiding core region. Similarly, fibre-to-fibre coupling will not require the same level of delicate aligning as would normally be required to align the core regions of different fibres in the transverse and longitudinal directions. Two terminated fibres may be aligned in a relatively crude way to achieve the result which is illustrated in FIG. 6 of the drawings.

Various methods may be employed to effect restriction of the holes 13 over a selected distance in any given fibre.

A short distance at the terminal end of the fibre may be squeezed by a suitable clamping connector in a manner to close the holes 13, either abruptly or in a progressive manner.

Thermal procedures may also be employed to effect controlled restriction of the cross-sectional areas of the holes. That is, local controlled heating of a cleaved facet of the fibre may be employed to cause melting of the fibre material adjacent the terminal end, so that the holes 13 will be closed or partially closed with liquefied fibre material over the required distance. Heating of the terminal end may be combined with simultaneous thermal moulding, squeezing and/or reshaping of the terminal end, or by fusing the terminal end of the fibre into a suitable connector.

As a further alternative, material may be introduced into the holes 13 over a required distance at the terminal end of the fibre. This approach will permit a controlled change to be made in the refractive index of the core-surrounding region 12 adjacent the terminal end of the fibre.

Settable liquid may be directed into the holes for the desired distance by creating a suction pressure within the holes, by inducing capillary movement of the liquid and/or by pressurising the liquid within a bath so that it is caused to penetrate the holes at, the terminal end of the optical fibre.

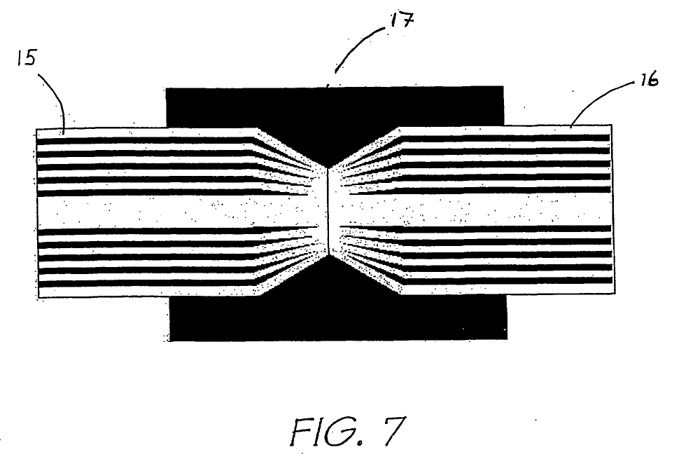

Referring to FIG. 7, a method of splicing two polymer optical fibres will now be described. Two polymer optical fibres 15 and 16 may be cut in a rough manner and aligned within a suitably shaped die 17. The die is equipped with heating facilities and comprises two mutually converging, aligned conical portions which are joined at their smaller ends. When the die 17 is heated and the two optical fibres 15 and 16 are pushed into the conical portions, the polymeric material will collapse and at least part of the holes will close. The heat, in addition, fuses the terminal ends of the two fibres together.

The die 17 may be composed of metal coated with teflon and may comprise two halves which can be split after the fibres are fused to permit removal of the spliced fibres. A low-refractive index coating material may be applied to the splice region for extra protection and to prevent leakage. When the spliced fibres are in use, a photonic signal guided in one of the fibres is initially confined by the hole-structure in the fibre. When passing through the spliced region it will detach from the core as defined by the holes, squeeze through the spliced region (which is surrounded by low index material) and will be funnelled into the core of the second fibre.

Although the invention has been described with reference to particular examples, it will be appreciated by those skilled in the art that the invention may be embodied in many other forms.

It is to be understood that the art publication referred to herein does not constitute a publication that forms a part of the common general knowledge in the art in Australia or any other country.

1. A method of terminating an optical fibre of a type formed from a polymeric material and having a longitudinally extending light guiding core region and light confining elements in the form of longitudinal extending channel-like holes; the method comprising restricting the cross-sectional area of at least some of the holes over a portion of their length adjacent a terminal end of the optical fibre, the cross-sectional area of the holes being restricted, using the inherent properties of the polymeric material, in a manner effectively to increase the cross-sectional area of the light guiding region of the optical fibre adjacent the terminal end of the optical fibre.

2. The method of terminating an optical fibre as claimed in claim 1 wherein restricting the cross-sectional area of at least some of the holes is effected by subjecting the terminal end region of the optical fibre to mechanical compression in a radially inward direction.

3. The method of terminating an optical fibre as claimed in claim 1 or 2 wherein restricting the cross-sectional area of at least some of the holes is effected by elongation in the longitudinal direction of the fibre.

4. The method of terminating an optical fibre as claimed in claims 1 to 3 wherein restricting the cross-sectional area of at least some of the holes is effected by thermally collapsing the hole-surrounding material of the optical fibre.

5. The method of terminating an optical fibre as claimed in claim 4 wherein the thermal collapsing of the hole-surrounding material is effected by the application of a level of heat sufficient to allow thermal moulding, squeezing or reshaping.

6. The method of terminating an optical fibre as claimed in claims 4 or 5 wherein the thermal collapsing of the hole-surrounding material is effected by the application of a level of heat corresponding to that used for drawing of the optical fibre.

7. The method of terminating an optical fibre as claimed in any one of the preceding claims wherein restricting the cross-sectional area of at least some of the holes is effected by filling the holes with a filling agent.

8. The method of terminating an optical fibre as claimed in claim 7 wherein the filling agent is a settable liquid.

9. The method of terminating an optical fibre as claimed in any one of the preceding claims wherein the cross-sectional area of the holes is partially restricted.

10. The method of terminating an optical fibre as claimed in any one of claims 1 to 8 wherein the cross-sectional area of the holes is wholly restricted.

11. The method of terminating an optical fibre as claimed in any one of claims 1 to 8 wherein the cross-sectional area of some of the holes is wholly restricted and that of others is partially restricted.

12. The method of terminating an optical fibre as claimed in any one of the preceding claims wherein all of the holes are restricted over the same distance with respect to the terminal end of the optical fibre.

13. The method of terminating an optical fibre as claimed in any one of the claims 1 to 11 wherein the distance over which the holes are restricted is reduced with increasing radial distance of the holes from the light guiding core region of the optical fibre.

14. The method of terminating an optical fibre as claimed in any one of the preceding claims wherein restricting the cross-sectional area of at least some of the holes is effected in a circularly symmetrical manner.

15. The method of terminating an optical fibre as claimed in any one of claims 1 to 13 wherein the restriction of the holes is effected by subjecting the terminal end region of the optical fibre to mechanical compression in the direction of a single radial line.

16. A method of splicing two optical fibres, each being of a type formed from a polymeric material and having a longitudinally extending light guiding core region and light confining elements in the form of longitudinal extending channel-like holes; the method comprising the steps of:
terminating each of the optical fibres by the method as claimed in any one of the preceding claims,
aligning the two optical fibres and
conjoining the terminal ends of the two aligned optical fibres.

17. The method of splicing two optical fibres as claimed in claim 16 wherein the splicing step is effected simultaneously with the terminating step following the alignment step.

18. The method of splicing two optical fibres as claimed in claim 17 wherein the steps of terminating and splicing are effected by the application of thermal energy.

19. The method of splicing two optical fibres as claimed in claim 18 wherein the terminal ends of the two optical fibres are positioned within a die having mutually converging conical portions, whereby the terminal ends of the optical fibres are subjected to compressive forces at the same time as they are exposed to the thermal energy.

20. The method of splicing two optical fibres as claimed in claims 18 or 19 wherein the thermal energy is sufficient to allow thermal moulding, squeezing or reshaping of the optical fibre.

21. The method of splicing two optical fibres as claimed in claims 18 or 19 wherein the thermal energy corresponds to that used for drawing of the optical fibre.

22. An optical device that comprises or incorporates an optical fibre which is terminated by the method as claimed in any one of the claims 1 to 15.

23. An optical device that comprises or incorporates two optical fibres which are spliced by the method as claimed in any one of the claims 16 to 21.
